(19) United States
(12) Patent Application Publication
(10) Pub. No.: US 2012/0056054 A1
(43) Pub. Date: Mar. 8, 2012

(54) FASTENING ELEMENT AND METHOD FOR FASTENING AN AIRBAG OF A VEHICLE OCCUPANT RESTRAINT SYSTEM TO A VEHICLE STRUCTURE

(75) Inventor: Oliver GLÖCKLER, Nersingen (DE)

(73) Assignee: TAKATA-PETRI AG

(21) Appl. No.: 13/298,754

(22) Filed: Nov. 17, 2011

Related U.S. Application Data
(63) Continuation of application No. PCT/EP2010/056523, filed on May 12, 2010.

(30) Foreign Application Priority Data
May 18, 2009 (DE) 10 2009 022 044.5

(51) Int. Cl. B60R 21/02; B23P 11/00

(52) U.S. Cl. 248/224.8; 29/525.08

(57) ABSTRACT

A fastening element for fastening an airbag of a vehicle occupant restraint system to a vehicle structure is provided. The fastening element comprising fixing means, by way of which the fastening element can be fixed in a fastening opening of the vehicle structure; and at least one feed-through opening for feeding through a connecting element by way of which the airbag is to be connected to the vehicle structure. The fastening element has at least one projection against which a connecting element of the airbag fed through the feed-through opening rests and which counteracts the connecting element from being pulled out of the feed-through opening. The invention also relates to a method for fastening an airbag of a vehicle occupant restraint system to a vehicle structure.

### CROSS-REFERENCE TO A RELATED APPLICATION

This application is a continuation of International Patent Application Number PCT/EP2010/056523, filed on May 12, 2010, which was published in German WO 2010/133490. The foregoing international application is incorporated by reference herein.

### BACKGROUND

The invention relates to a fastening element for fastening an airbag of a vehicle occupant restraint system to a vehicle structure as well as a method for fastening an airbag to a vehicle structure.

Airbags (in particular curtain airbags) of a vehicle occupant restraint system are connected for instance via connecting elements in form of fixing tapes to a vehicle structure. For this a fastening element is for instance used being definable on the vehicle structure (such as a part of the vehicle body), wherein a sewed loop of the connecting tape is defined on the fastening element.

### SUMMARY

The object to be solved by the present invention is to provide a fastening element, at which a connecting element can be fixed in the simplest manner.

According to an exemplary embodiment of the invention a fastening element for fastening an airbag of a vehicle occupant restraint system to a vehicle structure is provided with
fixing means via which the fastening element can be fixed in a fastening opening of the vehicle structure; and
at least one feed-through opening for feeding through a connecting element via which the airbag is to be connected to the vehicle structure, as well as
at least one projection against which a connecting element of the airbag fed through the feed-through opening rests and which counteracts the connecting element from being pulled out of the feed-through opening.

As previously mentioned, the connecting element is in particular a connecting tape (in particular in form of a tension tape), the one end thereof is connected to the airbag (for instance in one piece) and its other free end is to be fixed via the fastening element to a vehicle structure (in particular in form of a part of the vehicle body). However, the fastening element according to the invention can also in principle be used with non-tape like connecting elements.

The fastening element according to the invention is in particular used for fixing curtain airbags to a vehicle side structure such as for instance A-column, C-column and/or a roof frame of the vehicle, also if the connecting element is of cause not restricted to this application.

The connecting element, which is used together with the fastening element, is made for instance out of a textile fabric (for instance one or more layers of an airbag material) or another, in particular elastic material, for instance of a non-textile material such as rubber or a plastic.

The fixing means of the fastening element allows in particular a detachable connection of the fastening element to the vehicle structure. However, the fixing means of the fastening elements are designed in particular such that they counteract a removal of the fastening element out of the fastening opening of the vehicle structure, that means a certain force and/or actuation of the fixing means has to occur for removing the fastening element, which does not occur during normal operation of a vehicle, in which the fastening element according to the invention is arranged, and also not during an activation of the vehicle occupant restraint system, of which the fastening element is a part of. That the fastening element can be fixed via the fixing means “in” a fastening opening of the vehicle structure comprises for instance the possibility that the fastening element can be fixed via the fixing means at an edge of the fastening opening.

The projection of the fastening element is in particular made such that it counteracts an unintended pulling of the connecting element out of the feed-through opening. It blocks for instance a movement against the insertion direction of the connecting element being fed through the feed-through opening. In particular a form-fitted or force-fitted, in particular friction-fitted, connection between the fastening element and the connecting element is obtained via the projection.

According to an exemplary variant of the invention the projection (in particular formed spike like) projects from an edge of the feed-through opening. The connecting element fed through the feed-through opening presses in the assembled status of the fastening element against the projection, whereby the connecting element is being retained. The projection engages for instance in case of a textile connecting element with the fabric of the connecting element and blocks thus the connecting element being pulled out of the feed-through opening. The feed-through opening can of cause be made such that the connecting element can be removed from the projection in order to feed the tape further through the feed-through opening or to pull it out again of the feed-through opening.

The projection extends for instance towards the feed-through opening, wherein it extends in particular in a plane with the edge of a feed-through opening. It is however also conceivable that the projection points indeed (with a directional component) to the feed-through opening, is however being bent off the plane of the edge of the feed-through opening; for instance in a direction, which points in the assembled status of the fastening element to the vehicle structure or in a direction, which points in the assembled status of the fastening element away from the vehicle structure.

It is however also conceivable that the projection of the fastening element according to the invention is not formed at the edge of the feed-through opening, but is arranged for instance with a distance to the feed-through opening. The projection projects for instance from a continuous section of the fastening element via which the connecting element can be guided such that it rests against the projection.

It is of cause also possible that the fastening element comprises multiple projections for instance in form of multiple projections projecting from an edge of the feed-through opening.

The projection comprises for instance a spike, which rests in the assembled status of the fastening element against the connecting element or even engages with the material of the connecting element such that in particular when using a textile connecting element a particular efficient retaining of the connecting element in the feed-through opening is effected. In a variant the projection is designed essentially triangular in a top view that means it comprises two sides continuing acute towards each other from a basic side (for instance the edge of a feed-through opening). It is also possible that the spike of the projection is formed curved in particular in order to prevent in particular a destruction of the connecting element of the airbag inserted into the feed-through opening.

The feed-through opening of the fastening element comprises for instance a continuous edge that means there exists no recess from an edge of the fastening element to the feed-through opening, via which the connecting element can be inserted into the opening such that the connecting element has to be threaded through the feed-through opening.

The feed-through opening of the fastening element being made in particular out of a metal or a plastic is formed for instance by stamping out a contour having the projection such that the projection is integrally formed with the remaining fastening element and forms a section of the edge of the feed-through opening. Furthermore, it is possible that the stamping out of the feed-through opening does not occur along a closed line, but that the stamped out portion of the fastening element comprises a section, which remains connected to the remaining fastening element. The stamped out portion is thus not removed from the fastening element, but solely flap like bent off as far that a feeding through of the connecting element through the feed-through opening is possible without problems.

In a further exemplary embodiment of the invention the fixing means comprise a section, which reaches in the assembled status of the fastening element through the fastening opening of the vehicle structure and rests against a backside of the vehicle structure, which faces away from the airbag to be fixed. The section of the fastening element resting against the back side is for instance obtained, because an area (for instance an end in case of a longitudinal design of the fastening element) of the fastening element is being bent off from the remaining fastening element. The section to be brought into contact with the back side of the vehicle structure is in particular bent off from the remaining fastening element such that an area of the fastening element is obtained, which can be displaced via an edge of the fastening opening of the vehicle structure and is thereby preloaded against the edge or another section of the vehicle structure.

Due to the preloading the section of the fastening element presses against the backside and therewith in particular a friction-fitted connection of the fastening element with the vehicle structure is obtained. It is also possible that the edge of the fastening opening of the vehicle structure (or another area) has structures (in particular recesses) with which the section of the fixing means arranged at the back side of the vehicle structure engages and thus realizes besides a friction-fitted connection also a form-fitted connection of the fastening element to the vehicle structure.

The fixing means have beside the section, which rests in the assembled status of the fastening element against a back side of the vehicle structure, in particular also a section, which rests in the assembled fastening element against a front side of the vehicle structure, which faces away from the backside of the vehicle structure.

This section of the fixing means resting against the front side realizes in particular a form-fitted and/or force-fitted connection of the fastening element to the front side of the vehicle structure. The edge of the fastening opening of the vehicle structure or another section of the vehicle structure comprises therefore for instance a recess, with which a structure of the section of the fixing means resting against the front side of the vehicle structure engages.

Furthermore, the section of the fastening element, which is to be rested against the front side of the vehicle structure, can be designed such that for instance being bent off from the remaining fastening element such that it is preloaded against the front side of the vehicle structure when the fastening element is assembled in the fastening opening of the vehicle structure and therefore presses against it such that due to the friction between the section resting against the front side and the front side a removal of the fastening element out of the fastening opening is counteracted.

The section of the fastening element to be brought in contact with the front side of the vehicle structure is in particular designed in form of a flap being bent off from the remaining fastening element. This flap like section of the fixing means extends for instance from an edge of the fastening element (from the opening being different from the feed-through opening) and is obtained in particular by stamping out a portion of the fastening element.

Furthermore, the section of the fixing means resting against the front side of the vehicle structure in the assembled status of the fastening element can comprise at least one projection, which is designed for instance in form of a spike or comprises a spike, which presses against the front side of the vehicle structure and realizes in particular an additional form fit between the fastening element and the vehicle structure front side.

The section of the fixing means, which is to be rested against the front side of the vehicle structure, is in particular connected via a curve of the fastening element to the section of the fixing means, which is to be rested against a backside of the vehicle structure, that means the fixing means are designed according to the type of a clamp, which can be clamped on an edge of the fastening opening of the vehicle structure. For instance the two sections oppose each other approximately and extend essentially parallel to the vehicle structure.

In another exemplary embodiment of the invention the fastening element comprises at least one further feed-through opening for feeding through the connecting element. The further feed-through opening can in particular serve a feeding of the connecting element through to the (actual) feed-through opening such that it rests tightly against the projection of the fastening element. The fastening element comprises for instance two of such further feed-through openings.

Furthermore, the fastening element can comprise at least one recess, which continuous from the (actual) feed-through opening and/or a further feed-through opening of the fastening element to an edge of the fastening element such that a connecting element can be inserted over the edge and through the recess into the feed-through opening or the further feed-through opening, that means the connecting element does not have to be threaded through the feed-through opening or the further feed-through opening. The “edge” of the fastening element relates in particular to a side of the fastening element, which continues vertical to a plane, along which the feed-through opening or the further feed-through opening extend.

In an exemplary variant the fastening element is designed longitudinally and the recess continuous from a front face of an end of the fastening element to a further feed-through opening being different from the (actual) feed-through opening such that the connecting element can be inserted via the front face of the fastening element into the further feed-through opening. The recess extends for instance over almost the complete width (looked at crosswise to the main extension direction of the fastening element) such that a connecting tape with the wide side facing the fastening element can be pressed into the further feed-through opening. The width of the further feed-through opening corresponds for instance essentially to the width of the connecting tape.

The recess is in particular limited laterally by nose-like projections, which prevent a sliding out of the connecting tape inserted into the further feed-through opening. Furthermore, the front face of the fastening element, which comprises the further feed-through opening, can continue bended relative to the remaining fastening element; in particular such that it extends in the assembled status of the fastening element away from the vehicle structure.

According to a further exemplary embodiment of the invention the fastening element comprises a recess, which continuous from a lateral edge of the fastening element to a further feed-through opening such that the connecting tape can be inserted via the lateral edge of the fastening element into the further feed-through opening. In this variant the connecting tape is thus aligned with its lateral edge towards the fastening element and is inserted via the recess into the further feed-through opening.

Furthermore, the further feed-through opening can have a height (that means an extension crosswise to the width of the opening), which corresponds approximately to the double or three times thickness of the connecting tape being used with the fastening element such that a connecting tape being fed through twice or three times through the further feed-through opening is clamped in a certain degree between edges of the further feed-through opening facing each other.

In a further exemplary embodiment of the invention the fastening element comprises a first and a second further feed-through opening as well as a first and a second recess, wherein the first recess continuous from a lateral edge of the fastening element to a first further feed-through opening and the second recess continues from a front face of an end of the fastening element to the second further feed-through opening. The fastening element is hereby in particular designed longitudinally, that means it has at least sectionally (in particular in the area of the feed-through opening) a larger extension in one direction (longitudinal direction) than in a direction (width) crosswise thereto. The here mentioned “lateral edge” of the fastening element extends thus vertical to a plane being spent by the longitudinal and width direction of the fastening element. The “front face” of the fastening element is in particular on an end of the fastening element while the fixing means are designed on its other end.

The invention relates also to an arrangement with an airbag, a fastening element as described above and a connecting element being fed through the said feed-through opening of the fastening element.

The invention relates furthermore to a method for fastening an airbag to a vehicle structure, which comprises the steps of:
providing a fastening element, which comprises at least one feed-through opening, through which a connecting element can be fed, and at least one projection;
feeding a connecting element via which the airbag is to be connected to the vehicle structure through the feed-through opening such that the connecting element rests against the projection and whereby it is counteracted a pulling of the connecting element out of the feed-through opening; and
inserting the fastening element into a fastening opening of a vehicle structure.

### BRIEF DESCRIPTION OF THE DRAWINGS

The invention is being explained in more detail in the following by the means of examples with reference to the figures.

FIGS. 1 to 5 show different views of a fastening element according to a first embodiment of the invention.

FIGS. 6 and 7 show different perspective illustrations of a fastening element according to a second embodiment of the invention.

FIGS. 8 to 12 show different variants of the arrangement of a connecting tape of an airbag to the fastening element according to the invention.

### DETAILED DESCRIPTION

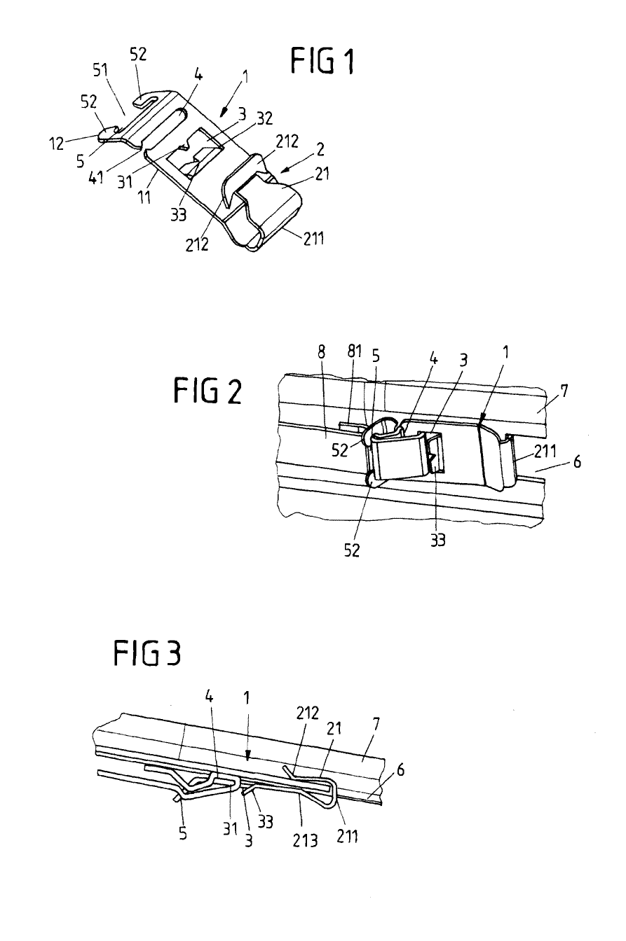

The fastening element 1 according to the invention illustrated in the FIGS. 1 to 5 has essentially a longitudinal shape, wherein fixing means 2 are provided on one end thereof via which the fastening element 1 can be fixed in a fastening opening of a vehicle structure; compare in particular FIGS. 2 and 3, which show fastening element 1 being assembled in a fastening opening 6 of a vehicle structure 7. The specific design of the fixing means will be explained further below.

The fastening element 1 comprises furthermore a feed-through opening 3 through which a connecting element in form of a connecting tape 8 (compare FIGS. 2 and 3), in particular for fastening a curtain airbag to a vehicle structure, is to be fed. The fastening element 1 comprises furthermore a projection 31 continuing acutely towards the feed-through opening 3 wherein said projection projects from an edge 32 of the feed-through opening 3, more precise forms a section of the edge 32 by itself. The connecting tape 8 is to be guided through the feed-through opening 3 such that it rests against the projection 31 so that it engages in particular with the connecting tape or is at least pressed into said connecting tape so that a pulling of the connecting tape out of the feed-through opening 3 is counteracted.

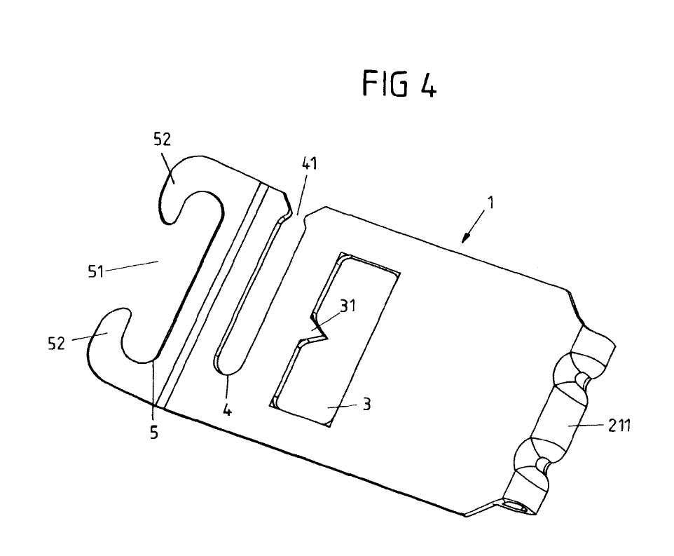

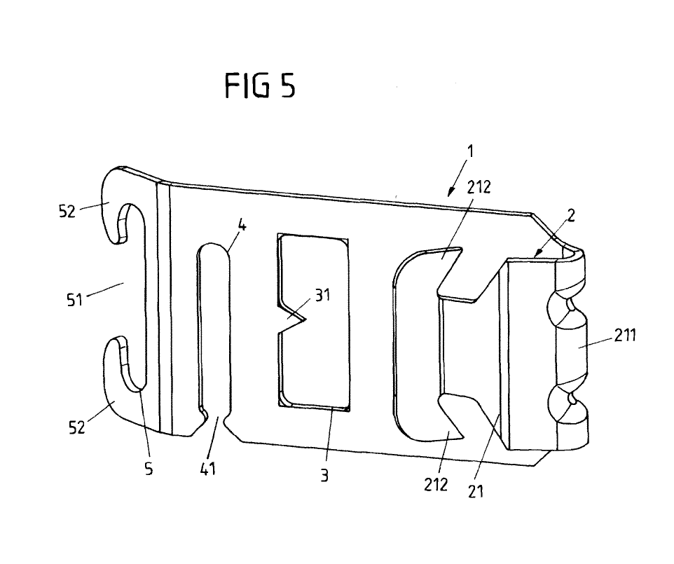

The acute projection 31 can be in particular made by stamping out a material portion 33 of the fastening element, wherein the stamped out area 33 remains connected on a side of the opening 3 being opposite to the projection 31 to the remaining fastening element and the feed-through opening 3 is being obtained by bending off the area 33. The material area 33 is bent off from the edge of the feed-through opening 3 as so much that the guiding of the connecting tape through the feed-through opening 3 is not hindered. The area 33 is in particular bent off to a side of the fastening element 1, wherein said side faces away from the vehicle structure in the assembled fastening element. FIGS. 4 and 5 show insofar a modification of the FIGS. 1 to 3 as the opening 3 was obtained here as a complete stamping out that means along a continuous stamping line without that a section of the stamping out portion remains connected to the fastening element.

The fastening element 1 according to the invention comprises beside the feed-through opening 3 a first further feed-through opening 4 as well as a second feed-through opening 5. A recess 41 continues from a lateral edge 11 of the fastening element to the first further feed-through opening 4 through which the connecting tape can be inserted into the further feed-through opening 4. Furthermore, a recess 51 extends from a front face 12 of the fastening element 1 formed at one end of the fastening element to the second further feed-through opening 5 via which the connecting tape can be inserted into the second further feed-through opening 5.

The recess 51 has a width (crosswise to the longitudinal extension of the fastening element), which corresponds almost to the width of the second further feed-through opening 5 so that the connecting tape being aligned parallel to the fastening element can be pressed into the opening 5. The recess 51 is limited laterally by noses 52, which form simultaneously a section of the edge of the second further feed-through opening 5, and which prevent a sliding of the section of the connecting tape being inserted into the feed-through opening 5 through the recess 51.

The fixing means 2 are designed according to the type of a clamp and comprise a section 21, which is bent off from the remaining fastening element 1 by about 180°, that means the section is connected via a corresponding curve 211 to the remaining fastening element 1. As illustrated in particular in FIG. 3 the section 21 is guided in a fastening opening 6 of a vehicle structure 7 and is pushed over an edge of the fastening opening 6 until an internal side of the curve comes in contact with the edge of the fastening opening 6 and the section 21 rests against a side of the vehicle structure facing away from the remaining fastening element 1.

The section 21 is bent off relative to the remaining fastening element such that it has to be again somewhat bent away relative to an opposing section of the fastening element for pushing over the edge of the fastening opening 6, whereby said section presses in the assembled status of the fastening element preloaded against the back side of the vehicle structure 7 and thus a form-fitted and/or force-fitted, in particular friction-fitted, connection of the section 21 to the back side of the vehicle structure 7 and thus the complete fastening element is obtained.

In order to obtain in particular an additional form-fitted connection to the vehicle structure the section 21 comprises at its free end an anchor like portion from which two acute tapering projections 212 extend such that they rest against the back side of the vehicle structure 7 in the assembled status of the fastening element. A section 213 of the fastening element opposing the projections 212 rests simultaneously against the front side of the vehicle structure such that the fastening element is clamped in particular via the projections 212 and the section 213 to the edge area of the fastening opening 6.

The FIGS. 2 and 3 show the fastening element 1 of FIG. 1 with inserted connecting tape 8 via which an airbag (not shown) is fixed to the vehicle structure (for instance in form of a part of the vehicle body). In order to fix the connecting tape 8 to the fastening element 1 said tape is guided with one end at first through the second further opening 5 and then is pulled from a front side of the fastening element 1, which faces away from the vehicle structure 7 in the assembled status of the fastening element, through the feed-through opening 3 such that the tape 8 rests against the projection 31.

The tape 8 being guided through the feed-through opening 3 continuous then on a back side of the fastening element 1 to the first further feed-through opening 4, is being guided through said opening and emerges from the fastening element through the second further feed-through opening 5, wherein the emerging end 81 of the connecting tape 8 continuous through the second further feed-through opening 5 such that it continuous between a section of the tape 8 entering the fastening element 1 and the fastening element 1. Tape 8 is thus somewhat tightly clamped between the noses 55 and the edge of the second further feed-through opening 5 being opposite to the noses 52. Tape 8 is in particular lashed in the fastening element 1 such that the projection 31 engages with the material of the tape (for instance a textile fabric) or presses at least into the material such that a pulling (by exerting a force against the insertion direction of the tape that means in direction of the airbag to be fixed) is in particular hindered during the unfolding of the airbag or is almost avoided.

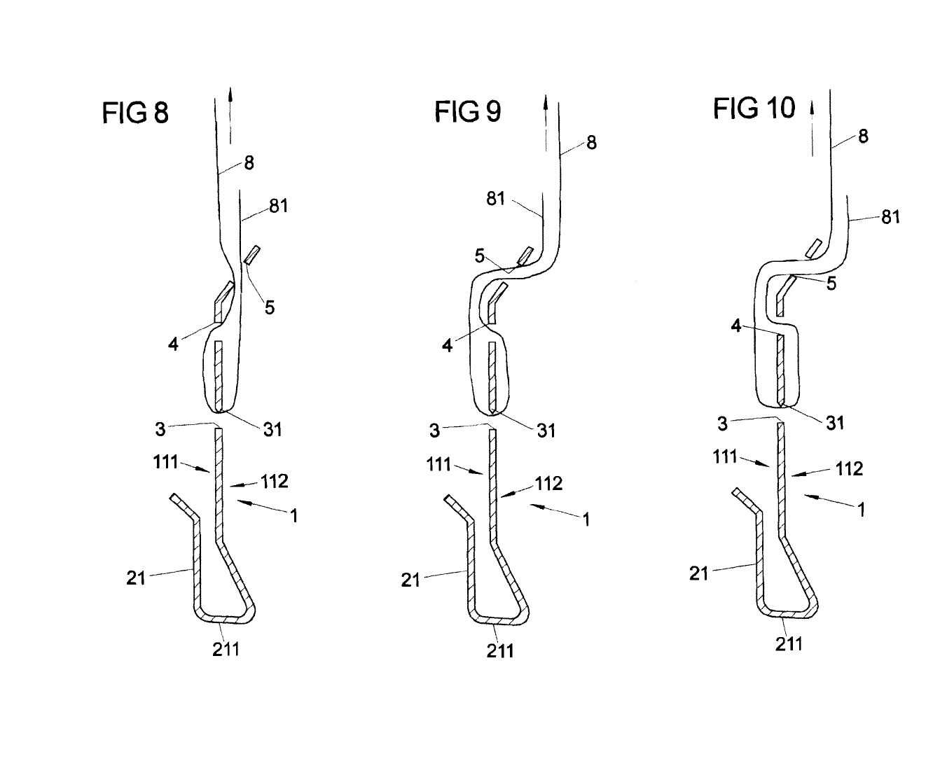

It is pointed out that the possibility illustrated in FIGS. 2 and 3 to connect the connecting tape 8 to the fastening element 1 is not the only possibility but of cause different possibilities exist to guide the tape through the feed-through openings 3, 4 and 5; compare FIGS. 8 to 12, which illustrate exemplarily further variants.

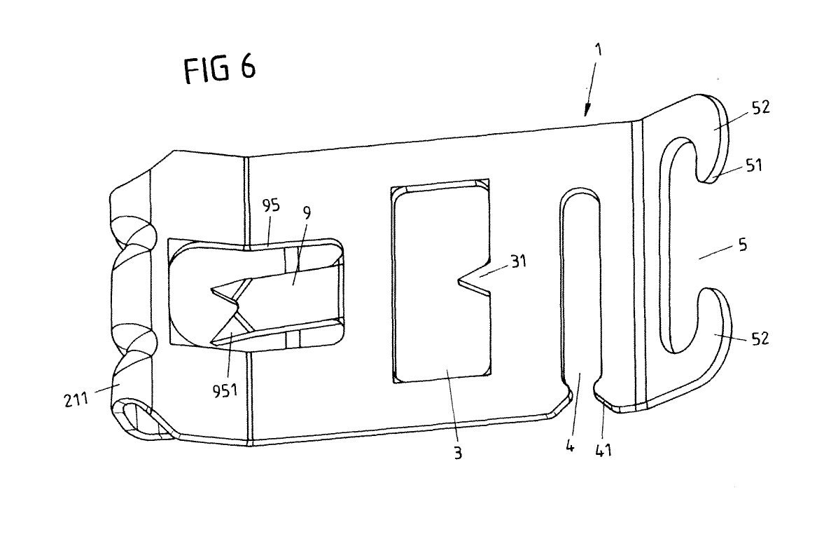

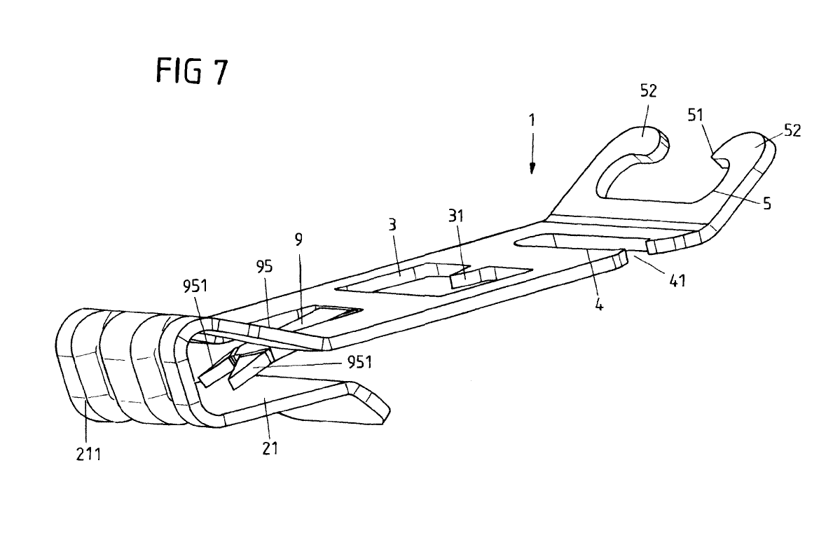

FIGS. 6 and 7 show two different perspective illustrations of a fastening element 1 according to a further embodiment of the invention. The fastening element 1 comprises thus according to the fastening element of the FIGS. 1 to 5 a first feed-through opening 3 with a projection 31 as well as a first and a second further feed-through opening 4, 5. The area of the fastening element, which serves for fixing a connecting type, is in particular designed in analogy to the FIGS. 1 to 5.

In contrast to the FIGS. 1 to 5 the fastening element according to the FIGS. 6 and 7 comprises however fixing means, which comprise a projecting section 9, which rests against a front side of the vehicle structure in the assembled status of the fastening element 1. The section 9 was cut freely out of the fastening element such that it projects flap like from an edge of an opening 95 and is in particular bent off from the edge of the opening 95 such that it is preloaded against the front side of the vehicle structure in the assembled fastening element.

The flap like projection 9 has on its free end acute tapering teeth 951 via which said projection rests against the front side of the vehicle structure in the assembled fastening element. The teeth 951 serve in particular to obtain a certain anchoring of the projection 9 at the front side of the vehicle structure such that it a removal of the fastening element out of the fastening opening of the vehicle structure is as much as possible counteracted. It is pointed out that the teeth do not have to be necessarily designed in an acute manner. It is also conceivable that said teeth rest against the front side of the vehicle structure within essentially even side or that the projection does not have any teeth.

The fastening element 1 comprises furthermore similar to the fastening element according to the first embodiment a section 21 being bent off from the remaining fastening element, which rests at least partially against a back side of the vehicle structure (not shown) in the assembled fastening element and which is bent relative to the remaining fastening element in particular such that it presses in an assembled status preloaded against the back side of the vehicle structure. However, the section 21 of FIGS. 6 and 7 does not have any projections, but rather only a final section being bent from the remaining fastening element, wherein said final section forms a gripping barrier via which section 21 can be bent off from the opposing section of the fastening element before pushing onto the edge of the fastening opening.

FIGS. 8 to 12 relate as mentioned to different possibilities to connect the connecting tape 8 to the fastening element 1 according to the invention, wherein the FIGS. 8 to 12 show in each case sectional views of the fastening element and the connecting tape.

FIG. 8 shows a possibility similar to the variant of FIG. 2, whereby the connecting tape coming from a front side 112, which faces away from the vehicle structure in the assembled status of the fastening element, of the fastening element 1 is guided through the feed-through opening 3, such that it rests tightly against the projection 31. Tape 8 leaves the fastening element through the first and the second further feed-through opening 4, 5.

A modification of the course of the connecting tape 8 trough the opening 3, 4 and 5 of the fastening element 1 is shown in FIG. 9. Accordingly tape 8 is inserted from the front side 112 of the fastening element into the front (second) further feed-through opening 5, continues then coming from the backside 111 of the fastening element 1 facing away from the front side 112 through the first further feed-through opening 4 and through the feed-through opening 3, wherein it rests tightly against the projection 31. The free end 81 of the airbag tape 8 extends then at the back side 111 of the fastening element to the second further feed-through opening 5 and emerges through said opening from the fastening element 1.

The variant according to FIG. 10 resembles FIG. 9, wherein the tape 8 after entering the fastening element continues through the second further feed-through opening 5 along the backside 111 of the fastening element in order to go through the feed-through opening 3 to the front side and to continue to the first further feed-through opening 4 along the front side 112 of the fastening element. After continuation through the first further feed-through opening 4 the tape emerges through the second further feed-through opening 5 from the fastening element 1, wherein the free end 81 of the tape 8 is located outside, that means the section of tape 8 entering the fastening element 1 is arranged between the fastening element 1 and the free end 81.

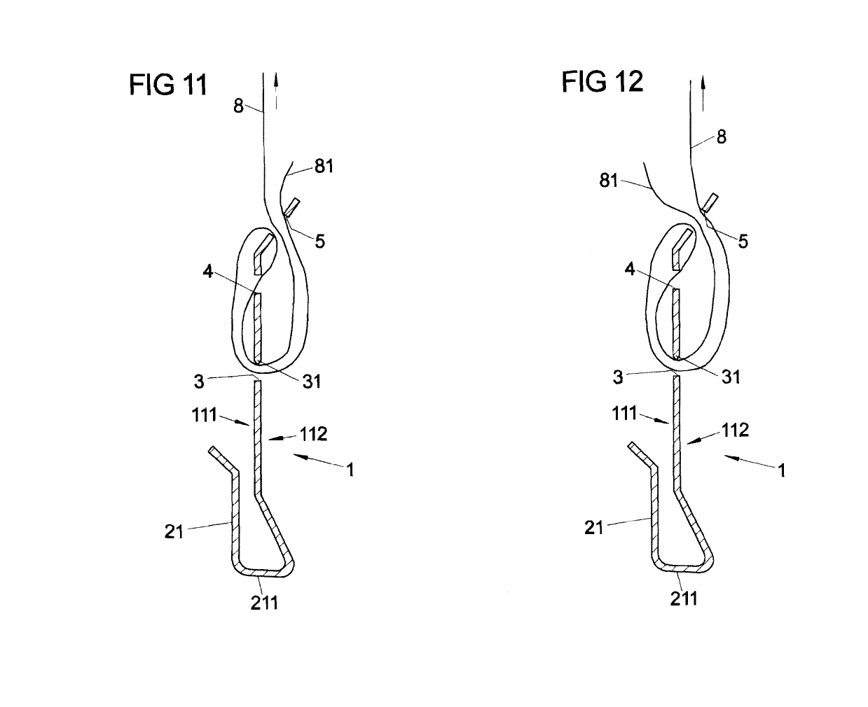

According to FIG. 11 tape 8 is pulled twice through the feed-through opening 3 in order to obtain a stable as possible connection of the tape to the fastening element. More precise the connecting tape 8 is inserted at first through the second further feed-through opening 5 into the fastening element 1, continues then along the front side 112 of the fastening element until the feed-through opening 3 and through said feed-through opening. Afterwards the tape coming from the backside 111 is guided through the first further feed-through opening 4 to the front side 112 and is subsequently threaded through the second further feed-through opening 5 in order to continue coming from the backside 111 once more through the feed-through opening 3 and subsequently leaves the fastening element 1 through the second further feed-through opening 5.

A variant being similar to the one in FIG. 11 is shown in FIG. 12, whereby tape 8 is again inserted through the second further feed-through opening 5 into the fastening element and is guided along the front side 112 to the feed-through opening 3 and is threaded through said feed-through opening. Subsequently the tape is pulled along the backside 111 until the second further feed-through opening 5 and is guided through said opening and through the first further feed-through opening 4 again through the feed-through opening 3 and finally emerges from the fastening element via the second further feed-through opening 5.

The application of the fastening element according to the invention is of cause not limited to the specific variant of threading the connecting tape 8 through the feed-through openings of the fastening element, but rather also other variants than the ones illustrated in the FIGS. 8 to 12 can be used. It is furthermore pointed out that elements of the previously described embodiments can also be used in combination with each other, for instance it is conceivable that the fixing means of the fastening element are provided with projections 212, which are to be rested against a backside of the vehicle structure, as well as with a projection 9, which is to be rested against a front side of the vehicle structure.

The priority application, German Patent Application Number 10 2009 022 044.5, filed on May 18, 2009 is incorporated by reference herein.

1. A fastening element for fastening an airbag of a vehicle occupant restraint system to a vehicle structure comprising
fixing means via which the fastening element can be fixed in a fastening opening of the vehicle structure, and
at least one feed-through opening for feeding through a connecting element (8) via which the airbag is to be connected to the vehicle structure,
wherein at least one projection against which a connecting element of the airbag fed through the feed-through opening rests and which counteracts the connecting element from being pulled out of the feed-through opening and
wherein the fastening element is formed in one piece.

2. The fastening element according to claim 1, wherein the projection projects from an edge of the feed-through opening or forms a section of an edge of the feed-through opening.

3. The fastening element according to claim 1, wherein the projection extends towards the feed-through opening.

4. The fastening element according to claim 1, wherein the fixing means are formed according to the type of a clamp, which can be clamped to the edge of the fastening opening of the vehicle structure.

5. The fastening element according to claim 1, wherein
the fixing means comprise a section, which reaches in the assembled status of the fastening element through the fastening opening of the vehicle structure and rests against a back side of the vehicle structure, which faces away from the airbag to be fixed, and/or
the fixing means comprise a section, which rests in the assembled status of the fastening element against a front side of the vehicle structure facing away from the back side.

6. The fastening element according to claim 5, wherein the section resting against the back side and/or the section of the fixing means resting against the front side form a form fitting and/or force fitting, in particular friction fitting, connection of the fixing means to the back or front side of the vehicle structure.

7. The fastening element according to claim 5, wherein the section of the fixing means resting against the back side is preloaded such that it presses in the assembled status of the fastening element against the backside of the vehicle structure.

8. The fastening element according to claim 5, wherein the section of the fixing means resting against the front side is preloaded such that it presses in the assembled status of the fastening element against the front side of the vehicle structure.

9. The fastening element according to claim 5, wherein the section resting against the back side and/or the section of the fixing means resting against the front side comprises at least one projection.

10. The fastening element according to claim 5, wherein the fastening element comprises a longitudinal shape and the section of the fixing means resting against the back side is being formed at an end of the fastening element being bent off relative to the remaining fastening element.

11. The fastening element according to claim 5, wherein the section of the fixing means resting against the front side projects flap like from the remaining fastening element.

12. The fastening element according to claim 5, wherein the section of the fixing means resting against the front side projects flap like from an edge of an opening of the fastening element being different from the feed-through opening.

13. The fastening element according to claim 1, further comprising at least one further feed-through opening for feeding through the connecting element.

14. The fastening element according to claim 1, further comprising at least one recess, which continuous from the feed-through opening and/or the further feed-through opening to an edge of the fastening element, such that the connecting element can be inserted through the recess into the feed-through opening or the further feed-through opening.

15. The fastening element according to claim 14, further comprising at least one further feed-through opening for feeding through the connecting element, wherein the fastening element is formed longitudinally and the recess continuous from one front face of an end of the fastening element to the further feed-through opening, such that the connecting element can be inserted via the front face into the further feed-through opening.

16. The fastening element according to claim 14, further comprising at least one further feed-through opening for feeding through the connecting element, wherein the fastening element is formed longitudinally and the recess continuous from a lateral edge of the fastening element to the further feed-through opening such that the connecting element can be inserted via the lateral edge into the further feed-through opening.

17. The fastening element according to claim 1, further comprising a first and a second further feed-through opening as well as a first and a second recess, wherein the first recess continuous from a lateral edge of the fastening element to the first further feed-through opening and the second recess continuous from a front face of an end of the fastening element to the second further feed-through opening.

18. The fastening element according to claim 1, wherein the feed-through opening is spaced apart from the fixing means such that it is positioned in the assembled status of the fastening element spaced apart from the fastening opening of the vehicle structure.

19. An arrangement of an airbag, a fastening element according to claim 1 and a connecting element fed through the feed-through opening of the fastening element.

20. A method for fastening an airbag to a vehicle structure with the steps of:
providing a fastening element, which comprises at least one feed-through opening and at least one projection and which is formed in one piece;
feeding through the connecting element via which the airbag is to be connected to the vehicle structure through the feed-through opening, such that the connecting element rests against the projection and thus counteracts the connecting element from being pulled out of the feed-through opening; and
inserting the fastening element into a fastening opening of a vehicle structure.
